(19) United States
(12) Patent Application Publication
(10) Pub. No.: US 2006/0111930 A1
(43) Pub. Date: May 25, 2006

(54) Automated refund process

(75) Inventors: Narayan Ayer, Pleasanton, CA (US); Sean Handel, Moss Beach, CA (US)

Correspondence Address: GREENBERG TRAURIG, LLP, 1900 UNIVERSITY AVENUE, FIFTH FLOOR, EAST PALO ALTO, CA, 94303, US

(73) Assignee: Rearden Commerce,Inc.

(21) Appl. No.: 11/292,849

(22) Filed: Dec. 1, 2005

Related U.S. Application Data
(63) Continuation-in-part of application No. 10/966,556, filed on Oct. 15, 2004.

(51) Int. Cl. G06Q 99/00

(52) U.S. Cl. 705/1

(57) ABSTRACT

A method and system to provide aggregate transit time. In one embodiment, the method, which may be performed by a system, comprises receiving information identifying a shipping destination; and in response to the information, providing data related to on-time performance for one or more shipping vendors providing shipping services to the destination. In one embodiment, a method, which may be performed by a system, is provided to track missed delivery deadlines, and may initiate an automatic or semi-automatic refund request in such cases.

The present application is a continuation-in-part of U.S. application Ser. No. 10/966,556, entitled “System for Optimization of Cost Management,” filed Oct. 15, 2004 (Attorney Docket No.: 76840-200801) which is incorporated herein by reference.

### BACKGROUND OF THE INVENTION

Often customers pay premium prices for delivery of merchandise at a specific time, such as early morning delivery, standard mid-morning delivery, etc. However, very often there is no good follow-up, especially in cases where large quantities of merchandise have been shipped, about whether these promised delivery times have been achieved. Often national carriers advertise their shipping times, such as two-day delivery, or over-night delivery, etc. And often carriers may advertise a national on-time average, such as 97 percent on-time delivery. However, for various particular regions, such as a certain city or ZIP code, the on-time average may be so much lower than the advertised national on-time average that a sender (merchant) or a buyer (customer) may find it advisable to use a different shipper or shipping method to obtain on-time delivery. Unfortunately, such on-time performance numbers for specific locations are not readily available from the shippers.

### SUMMARY OF THE INVENTION

A method and system to provide aggregate transit time. In one embodiment, the method, which may be performed by a system, comprises receiving information identifying a shipping destination; and in response to the information, providing data related to on-time performance for one or more shipping vendors providing shipping services to the destination.

In one embodiment, a method, which may be performed by a system, is provided to track the accuracy of on-time delivery and generally to map or to allow inquiries into percentages of on-time delivery, based on a specific address in a region, such as a ZIP code, a city, or a metropolitan area. Further, such inquiries may be sorted by all carriers to a target location and also by specific carriers to a target location. Such an approach may allow a sender to better gauge which method and which carrier has an advantageous on-time average in the regions of his customers, so the sender can better meet shipping deadlines.

In one embodiment, a method, which may be performed by a system, is provided to track missed delivery deadlines, and may initiate an automatic or semi-automatic refund request in such cases.

### BRIEF DESCRIPTION OF THE DRAWINGS

FIG. 1 shows an exemplary overview of a system for obtaining aggregate transit times of shipments, according to one embodiment;

FIG. 2 shows an outline map of the US, with three regions of interest as examples of areas for which specific shipping data may be aggregated, in accordance with one embodiment.

FIG. 3a shows an exemplary process flow for collecting information about shipping times to various points, in accordance with one embodiment;

FIG. 3b shows an exemplary process flow that permits users or systems to obtain information about on-time performance of various shippers for various locations, in accordance with one embodiment; and

FIG. 4 shows an shows an exemplary process flow of a software instance according to one embodiment, for automated refund applications.

### DETAILED DESCRIPTION OF THE INVENTION

In the following detailed description of embodiments of the invention, reference is made to the accompanying drawings in which like references indicate similar elements, and in which is shown by way of illustration specific embodiments in which the invention may be practiced. These embodiments are described in sufficient detail to enable those skilled in the art to practice the invention, and it is to be understood that other embodiments may be utilized and that logical, mechanical, electrical, functional, and other changes may be made without departing from the scope of the present invention. The following detailed description is, therefore, not to be taken in a limiting sense, and the scope of the present invention is defined only by the appended claims.

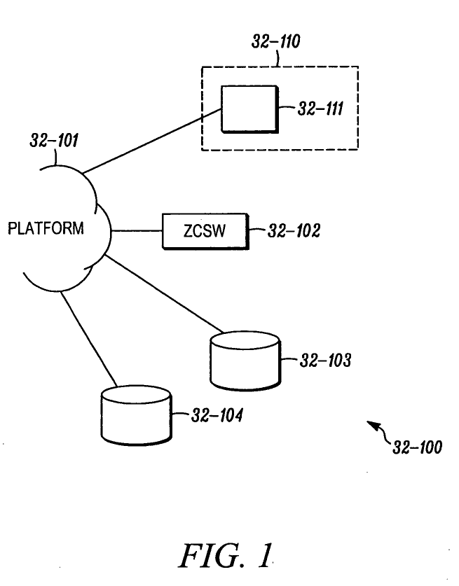

FIG. 1 shows an exemplary overview of a system 32-100 for obtaining aggregate transit times of shipments, in accordance with one embodiment. Said system 32-100 includes, in this example, Commerce Platform (CP) 32-101 as the basis. Connected to the CP 32-101 is a customer 32-110, who has a computer 32-111 that is used to set up shipments. The CP 32-101 has its own database 32-103. Additionally shown also connected to the CP 32-101 is a ZIP code software (ZCSW) instance 32-102 that can aggregate shipping information according to regions and addresses and store them in either main database 32-103 or, in cases where this may be a separate application, in a separate database 32-104. Variations of the arrangement of the CP 32-101 and its one or more databases, including but not limited to databases such as 32-103 and 32-104, may be provided.

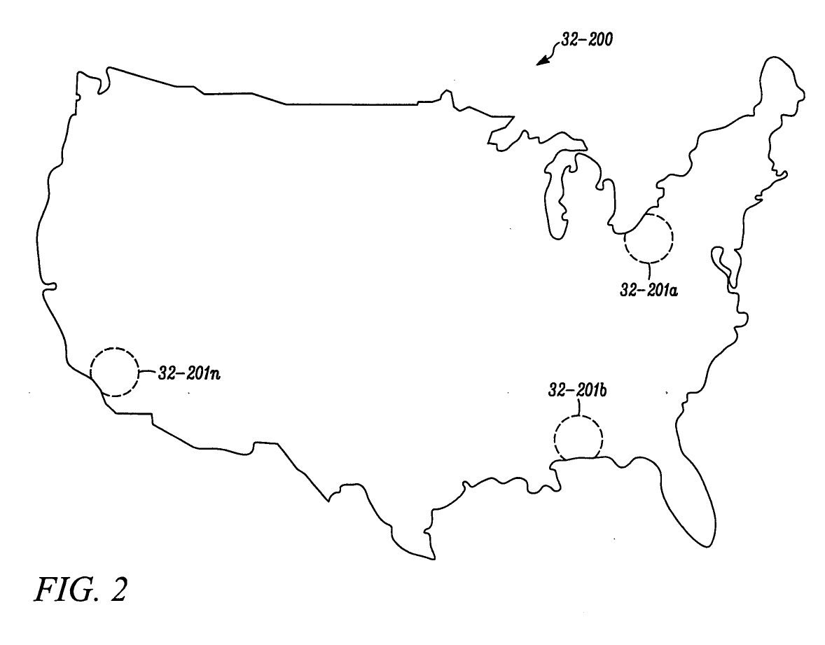

FIG. 2 shows an outline map 32-200 of the US, with three regions of interest 32-201a, 32-201b, and 32-201n, as examples of areas for which specific shipping data may be aggregated. The data may be for locations ranging from only a single street through a ZIP code, a city, a state, or a region. For example, region 32-201n could be for the city of Los Angeles (multiple ZIP codes), for the greater Los Angeles basin (multiple ZIP codes and cities), or for all of southern California (many more ZIP codes and cities).

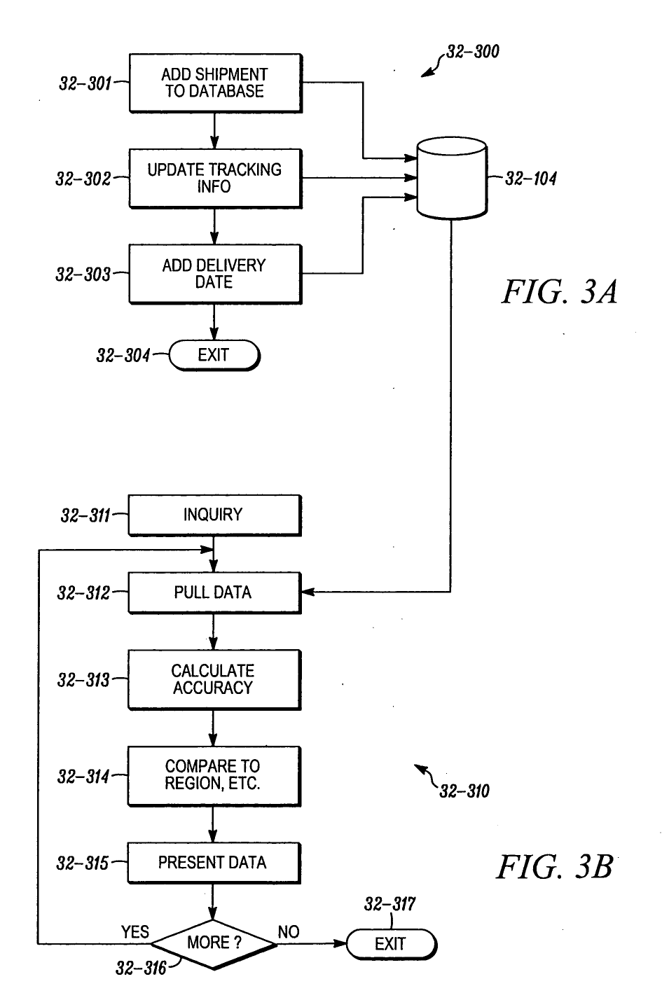

FIG. 3a shows an exemplary process flow 32-300 for collecting information about shipping times to various points. In step 32-301, shipment data is added to a database, in this example database 32-104. In step 32-302, shipping time information is updated as more information becomes available, and then final delivery performance data is updated in step 32-303. In step 32-304, the program terminates. The program might run, for example, daily on a batch basis for all shipments within the last 24 hours, or it might run as an event-triggered process, each time it receives a notification of shipment information, via email or some other communication. In some cases the program could scrape shipping time information from websites of carriers, otherwise referenced as shipping vendors. In any case, database 32-104 contains pertinent data about the shipment times, such as what service was ordered, when the shipment was booked, what type of carrier/shipping method (truck, air, train and truck, etc.), the pick-up and drop-off locations, and the actual pick-up and delivery dates.

FIG. 3b shows an exemplary process flow 32-310 that permits users or systems to obtain information about on-time performance of various shipping vendors for various locations and destinations. In step 32-311, a user enters an inquiry. In step 32-312 the data is pulled from database 32-104, and then in step 32-313, the program calculates the on-time averages for the location(s) or destinations entered by the user. The data may be compounded on a daily, weekly, or monthly basis, and satisfying the inquiry does not require further calculations. In step 32-314, information about one location and shipper may then be compared to regional or other desired or relevant comparison data, including but not limited to, for example, ZIP+4, house or unit address, street, postal route, ZIP plus phone number information, etc. Thus on-time performance for similar regions could be compared, or different metro areas could be compared, or different sections of a city could be compared. The data selections could be presented accordingly in step 32-315. At step 32-316, the program branches. If the user is satisfied with the information obtained and needs no more information (NO), he exits the program at step 32-317. If, however, the user wants more information (YES), the program loops back to step 32-312 and reruns the process according to the new inquiry of the user.

Database 32-104, as discussed earlier, in one embodiment, contains all the information about a shipment, including service ordered and the actual pick-up and delivery time. This data allows extraction of information about shipments with actual missed delivery times, so that refund applications may be emailed, printed for postal mailing, or sent as a screen or message to a call center or IVR or as a script to an IVR to be further processed as voice input. Different carriers/shipping vendors have various different requirements about requesting refunds. They are very particular about their requirements and, in most cases, do not accept deviations from the required procedure.

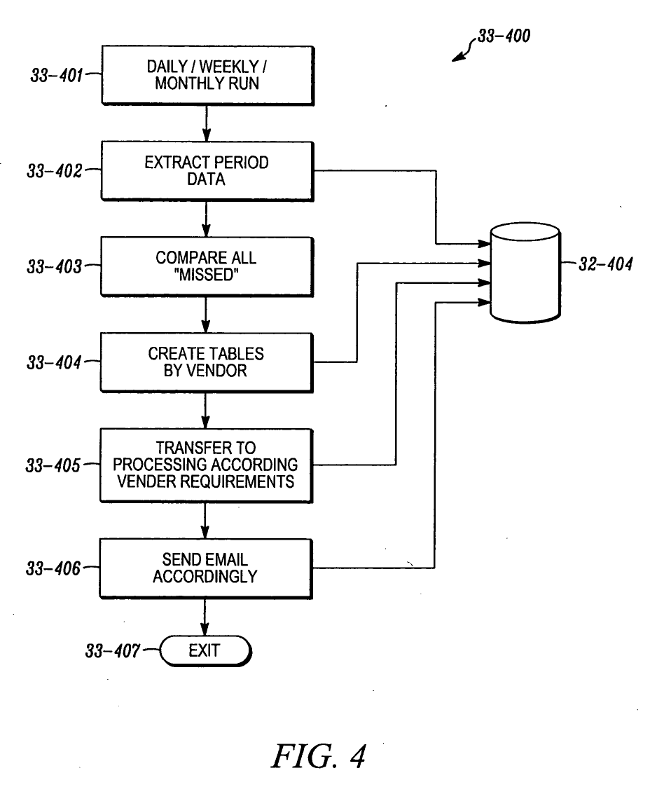

FIG. 4 shows an exemplary process flow 33-400 of a process or software instance according to one embodiment for automated refund applications. In step 33-404, daily, weekly, or monthly runs of the software are launched, according to the requirements of the system. In step 33-402, data is extracted from database 32-104, and in step 33-403, the process composes a list of missed delivery times; that is, deliveries where the actual provided service did not meet the service that was ordered and paid for (quality of service, also a service-level issue). In step 33-404, the data is then sorted by vendors, because different vendors may require different frequencies of submission, e.g., daily, monthly, etc., and also because different vendors require different modes and methods of submitting an application for a refund.

In step 33-405, the prepared logs for each vendor are transferred for processing according to the vendor requirements. In many cases, the submission of a refund request can be done by email, which is sent in step 33-406. In other cases, the program could email a notification of a refund due to a call center, which email would trigger a call to the carrier to request a refund, or requesting a refund might be a service offered internally in a corporation, so the program sends an email an internal employee, who then initiates a refund request. In yet other cases, the program may insert the particulars of the refund request into a form letter, and then send the letter to a printer for printing and mailing by postal mail. Then in step 33-407, the program terminates.

It is clear that many modifications and variations of this embodiment may be made by one skilled in the art without departing from the spirit of the novel art of this disclosure.

The processes described above can be stored in a memory of a computer system as a set of instructions to be executed. In addition, the instructions to perform the processes described above could alternatively be stored on other forms of machine-readable media, including magnetic and optical disks. For example, the processes described could be stored on machine-readable media, such as magnetic disks or optical disks, which are accessible via a disk drive (or computer-readable medium drive). Further, the instructions can be downloaded into a computing device over a data network in a form of compiled and linked version.

Alternatively, the logic to perform the processes as discussed above could be implemented in additional computer and/or machine readable media, such as discrete hardware components as large-scale integrated circuits (LSI's), application-specific integrated circuits (ASIC's), firmware such as electrically erasable programmable read-only memory (EEPROM's); and electrical, optical, acoustical and other forms of propagated signals (e.g., carrier waves, infrared signals, digital signals, etc.); etc.

It is clear that many modifications and variations of this embodiment may be made by one skilled in the art without departing from the spirit of the novel art of this disclosure.

What is claimed is:

1. A method comprising:
automatically identifying one or more occasions when a shipping vendor has missed a delivery time, by which the shipping vendor had agreed to provide shipment; and
automatically initiating a request for one of a price adjustment and at least partial refund from the shipping vendor.

2. The method of claim 1, wherein the automatically identifying is to be performed one of daily, weekly, or monthly.

3. The method of claim 1, wherein the automatically identifying further comprises automatically identifying, for multiple shipping vendors, instances of missed delivery times, by which respective shipping vendors had agreed to provide shipment.

4. The method of claim 3, further comprising sorting, by the multiple vendors, data identifying missed delivery times.

5. The method of claim 4, wherein the automatically initiating the request for one of a price adjustment and at least partial refund, further comprises automatically initiating the request for one of a price adjustment and at least partial refund from multiple shipping vendors.

6. The method of claim 5, wherein the automatically initiating the request further comprises submission of a refund request, to a respective shipping vendor, by email.

7. The method of claim 6, wherein the automatically initiating the request further comprises emailing a notification to a call center to have the call center contact the respective shipping vendor to request one of the price adjustment and at least partial refund.

8. The method of claim 5, wherein the automatically initiating the request further comprises initiating a message be sent to an employee, requesting or instructing the employee to request one of the price adjustment and at least partial refund.

9. A machine-readable medium having stored thereon a set of instructions which when executed, perform a method comprising:
automatically identifying one or more occasions when a shipping vendor has missed a delivery time, by which the shipping vendor had agreed to provide shipment; and
automatically initiating a request for one of a price adjustment and at least partial refund from the shipping vendor.

10. The method of claim 9, wherein the automatically identifying is to be performed one of daily, weekly, or monthly.

11. The method of claim 9, wherein the automatically identifying further comprises automatically identifying, for multiple shipping vendors, instances of missed delivery times, by which respective shipping vendors had agreed to provide shipment.

12. The method of claim 11, further comprising sorting, by the multiple vendors, data identifying missed delivery times.

13. The method of claim 12, wherein the automatically initiating the request for one of a price adjustment and at least partial refund, further comprises automatically initiating the request for one of a price adjustment and at least partial refund from multiple shipping vendors.

14. The method of claim 13, wherein the automatically initiating the request further comprises submission of a refund request, to a respective shipping vendor, by email.

15. The method of claim 14, wherein the automatically initiating the request further comprises emailing a notification to a call center to have the call center contact the respective shipping vendor to request one of the price adjustment and at least partial refund.

16. The method of claim 15, wherein the automatically initiating the request further comprises initiating a message be sent to an employee, requesting or instructing the employee to request one of the price adjustment and at least partial refund.

17. A system comprising:
a means for automatically identifying one or more occasions when a shipping vendor has missed a delivery time, by which the shipping vendor had agreed to provide shipment; and
a means for automatically initiating a request for one of a price adjustment and at least partial refund from the shipping vendor.

18. The system of claim 17, wherein the means for automatically identifying is to perform the identifying at least one of daily, weekly, or monthly.

19. The system of claim 17, wherein the means for automatically identifying further comprises means for automatically identifying, for multiple shipping vendors, instances of missed delivery times, by which respective shipping vendors had agreed to provide shipment.

20. The system of claim 19, further comprising a means for sorting, by the multiple vendors, data identifying missed delivery times.
